(19) United States
(12) Patent Application Publication
(10) Pub. No.: US 2017/0190418 A1
(43) Pub. Date: Jul. 6, 2017

(54) Electro-Mechanical Bridles for Energy Kites

(71) Applicant: X Development LLC, Mountain View, CA (US)

(72) Inventors: Elias Wolfgang Patten, Seattle, WA (US); Damon Vander Lind, Alameda, CA (US); Alex Yat Ning Chan, San Jose, CA (US); Jerome Francois Sicard, Oakland, CA (US); Nathan Treat, San Mateo, CA (US)

(21) Appl. No.: 14/984,369

(22) Filed: Dec. 30, 2015

(51) Int. Cl. B64C 31/06; H01B 5/10; H01B 9/00; H01B 7/00; F03D 9/00; H01B 7/04

(52) U.S. Cl. CPC B64C 31/06; F03D 11/04; F03D 9/002; H01B 7/043; H01B 9/008; H01B 7/0009; H01B 5/107

(57) ABSTRACT

An energy kite may be coupled to a tether and ground station via an electro-mechanical bridle. The energy kite may generate a significant amount of lift during power generation and may need to transfer this load to a tether that is anchored at the ground. Transferring the load at a single point would place a substantial bending moment on the energy kite. To mitigate this bending moment, the load may be divided between multiple locations with a bridle system. The bridle system may have a plurality of electrical conductors to conduct electrical power and signals.

### BACKGROUND

Unless otherwise indicated herein, the materials described in this section are not prior art to the claims in this application and are not admitted to be prior art by inclusion in this section.

Power generation systems may convert chemical and/or mechanical energy (e.g., kinetic energy) to electrical energy for various applications, s as utility systems. As one example, a wind energy system may convert kinetic wind energy to electrical energy.

### SUMMARY

Electro-mechanical bridles are described herein. The high-aspect ratio wing of an energy kite generates a significant amount of lift during power generation and needs to transfer this load to a tether that is anchored at or near the ground. Although a single tether may be closer to ideal for aerodynamics and efficiency, transferring the load from the wing to the tether at a single point would cause the long wing to experience a substantial bending moment. This substantial bending moment would require a very large and expensive structure. This bending moment and the need for a large and expensive structure can be mitigated by dividing the load transfer between the tether and the wing between multiple locations using one or more electro-mechanical bridles. Beneficially, embodiments of bridles described herein can be strong, fatigue resistant, aerodynamic, cost effective, and may allow for pitch and roll degrees of freedom of the energy kite.

In one aspect, an electro-mechanical bridle includes a structural member comprising wrapped fiber filaments. The electro-mechanical bridle includes a tether thimble coupled to a first end of the structural member that is configured to couple a tether to the electro-mechanical bridle. The electro-mechanical bridle includes a wing thimble coupled to a second end of the structural member. The wing thimble is configured to couple an aerial vehicle to the bridle. The electro-mechanical bridle also includes a plurality of electrical conductors coupled to the structural member and extending from the first end to the second end.

In another aspect, an electro-mechanical bridle system includes a first bridle comprising: a first structural member comprising a wrapped fiber; a first tether thimble coupled to a first end of the first structural member; and a first wing thimble coupled to a second end of the first structural member, wherein the first wing thimble is configured to couple an aerial vehicle to the first bridle. The electro-mechanical bridle system further includes a second bridle comprising: a second structural member comprising a wrapped fiber; a second tether thimble coupled to a first end of the second structural member; and a second wing thimble coupled to a second end of the second structural member, wherein the second wing thimble is configured to couple an aerial vehicle to the second bridle. The first tether thimble and the second tether thimble are configured to couple the first bridle and the second bridle to a tether. The electro-mechanical bridle also includes a plurality of electrical conductors coupled to the first bridle and extending the length of the first structural member.

In yet another aspect, an energy kite system includes a ground station coupled to an electrically conductive tether. The energy kite system includes a plurality of bridles, each bridle comprising: a structural member comprising a wrapped fiber; a tether thimble coupled to a first end of the structural member; and a wing thimble coupled to a second end of the structural member; wherein each tether thimble is coupled to the electrically conductive tether. The energy kite system also includes a plurality of electrical conductors extending the length of at least one of the plurality of bridles and electrically coupled to an aerial vehicle. The energy kite system also includes a power transfer loop configured to transfer electrical power or signals between the electrically conductive tether and the electro-mechanical bridle system. The wing thimbles are each coupled to the aerial vehicle.

These as well as other aspects, advantages, and alternatives, will become apparent to those of ordinary skill in the art by reading the following detailed description, with reference where appropriate to the accompanying drawings.

### BRIEF DESCRIPTION OF THE FIGURES

FIG. 1 depicts an Airborne Wind Turbine (AWT), according to an example embodiment.

FIG. 2 is a simplified block diagram illustrating components of an AWT, according to an example embodiment.

FIG. 3 depicts an aerial vehicle, according to an example embodiment.

FIG. 4 depicts an aerial vehicle coupled to a ground station via a tether, according to an example embodiment.

FIG. 5 depicts the aerial vehicle 330 coupled to the tether 120 via a bridle system 500, according to an example embodiment.

FIG. 6 depicts a bridle 600 in a first orientation and in a second orientation where the bridle 600 is turned 90 degrees from the first orientation, according to an example embodiment.

FIG. 6A depicts a bridle in cross-section, according to an example embodiment.

FIG. 6B depicts a bridle in cross-section, according to an example embodiment.

FIG. 7A depicts a bridle in cross-section, according to an example embodiment.

FIG. 7B depicts a bridle in cross-section, according to an example embodiment.

FIG. 7C depicts a bridle in cross-section, according to an example embodiment.

FIG. 7D depicts a bridle, according to an example embodiment.

FIG. 8A depicts a bridle 800, according to an example embodiment.

FIG. 8B depicts the bridle 800 in cross-section along line AA, according to an example embodiment.

### DETAILED DESCRIPTION

Exemplary systems and methods are described herein. It should be understood that the word “exemplary” is used herein to mean “serving as an example, instance, or illustration.” Any embodiment or feature described herein as “exemplary” or “illustrative” is not necessarily to be construed as preferred or advantageous over other embodiments or features. More generally, the embodiments described herein are not meant to be limiting. It will be readily understood that certain aspects of the disclosed systems can be arranged and combined in a wide variety of different configurations, all of which are contemplated herein.

### I. Overview

Illustrative embodiments relate to aerial vehicles, which may be used in a wind energy system, such as an energy kite, which may also be called an Airborne Wind Turbine (AWT). In particular, illustrative embodiments may relate to or take the form of bridles that may be used in AWTs.

By way of background, an AWT may include an aerial vehicle that flies in a closed path, such as a substantially circular path, to convert kinetic wind energy to electrical energy. In an illustrative implementation, the aerial vehicle may be connected to a ground station via a tether. While tethered, the aerial vehicle can: (i) fly at a range of elevations and substantially along the path, and return to the ground, and (ii) transmit electrical energy to the ground station via the tether, (In some implementations, the ground station may transmit electricity to the aerial vehicle for take-off and/or landing.)

In an AWT, an aerial vehicle may rest in and/or on a ground station (or perch) when the wind is not conducive to power generation. When the wind is conducive to power generation, such as when a wind speed may be 3.5 meters per second (m/s) at an altitude of 200 meters (m), the ground station may deploy (or launch) the aerial vehicle. In addition, when the aerial vehicle is deployed and the wind is not conducive to power generation, the aerial vehicle may return to the ground station.

Moreover, in an AWT, an aerial vehicle may be configured for hover flight and crosswind flight. Crosswind flight may be used to travel in a motion, such as a substantially circular motion, and thus may be the primary technique that is used to generate electrical energy. Hover flight in turn may be used by the aerial vehicle to prepare and position itself for crosswind flight. In particular, the aerial vehicle could ascend to a location for crosswind flight based at least in part on hover flight. Further, the aerial vehicle could take-off and/or land via hover flight.

In hover flight, a span of a main wing of the aerial vehicle may be oriented substantially parallel to the ground, and one or more propellers of the aerial vehicle may cause the aerial vehicle to hover over the ground. In some implementations, the aerial vehicle may vertically ascend or descend in hover flight. Moreover, in crosswind flight, the aerial vehicle may be oriented, such that the aerial vehicle may be propelled by the wind substantially along a closed path, which as noted above, may convert kinetic wind energy to electrical energy. In some implementations, one or more rotors of the aerial vehicle may generate electrical energy by slowing down the incident wind.

Embodiments described herein may relate to or take the form of an electro-mechanical bridle. In an illustrative implementation, the electro-mechanical bridle system may link together to form a “Y”-shaped system that is used to divide a load transfer between the tether and the aerial vehicle between multiple locations.

### II. Illustrative Systems

### A. Airborne Wind Turbine (AWT)

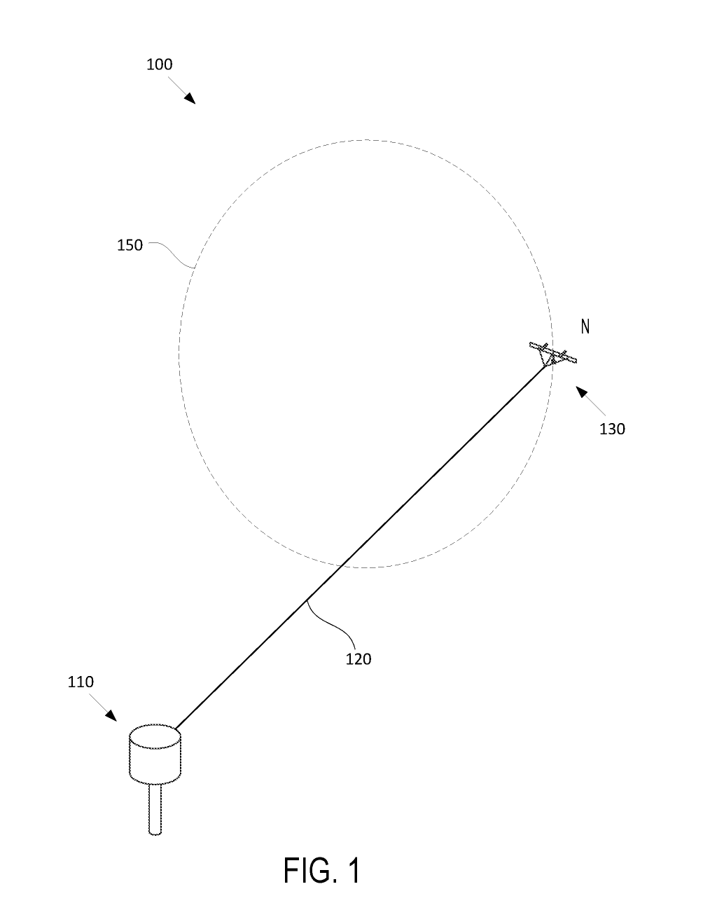

FIG. 1 depicts an AWT 100, according to an example embodiment. In particular, the AWT 100 includes a ground station 110, a tether 120, and an aerial vehicle 130. As shown in FIG. 1, the tether 120 may be connected to the aerial vehicle on a first end and may be connected to the ground station 110 on a second end. In this example, the tether 120 may be attached to the ground station 110 at one location on the ground station 110, and attached to the aerial vehicle 130 at three locations on the aerial vehicle 130. However, in other examples, the tether 120 may be attached at multiple locations to any part of the ground station 110 and/or the aerial vehicle 130.

The ground station 110 may be used to hold and/or support the aerial vehicle 130 until it is in an operational mode. The ground station 110 may also be configured to allow for the repositioning of the aerial vehicle 130 such that deploying of the device is possible. Further, the ground station 110 may be further configured to receive the aerial vehicle 130 during a landing. The ground station 110 may be formed of any material that can suitably keep the aerial vehicle 130 attached and/or anchored to the ground while in hover flight, crosswind flight, and other flight modes, such as forward flight (which may be referred to as airplane-like flight). In some implementations, a ground station 110 may be configured for use on land. However, a ground station 110 may also be implemented on a body of water, such as a lake, river, sea, or ocean. For example, a ground station could include or be arranged on a floating off-shore platform or a boat, among other possibilities. Further, a ground station 110 may be configured to remain stationary or to move relative to the ground or the surface of a body of water.

In addition, the ground station 110 may include one or more components (not shown), such as a winch, that may vary a length of the tether 120. For example, when the aerial vehicle 130 is deployed, the one or more components may be configured to pay out and/or reel out the tether 120. In some implementations, the one or more components may be configured to pay out and/or reel out the tether 120 to a predetermined length. As examples, the predetermined length could be equal to or less than a maximum length of the tether 120. Further, when the aerial vehicle 130 lands in the ground station 110, the one or more components may be configured to reel in the tether 120.

The tether 120 may transmit electrical energy generated by the aerial vehicle 130 to the ground station 110. In addition, the tether 120 may transmit electricity to the aerial vehicle 130 in order to power the aerial vehicle 130 for takeoff, landing, hover flight, and/or forward flight. The tether 120 may be constructed in any form and using any material which may allow for the transmission, delivery, and/or harnessing of electrical energy generated by the aerial vehicle 130 and/or transmission of electricity to the aerial vehicle 130. The tether 120 may also be configured to withstand one or more forces of the aerial vehicle 130 when the aerial vehicle 130 is in an operational mode. For example, the tether 120 may include a core configured to withstand one or more forces of the aerial vehicle 130 when the aerial vehicle 130 is in hover flight, forward flight, and/or crosswind flight. In some examples, the tether 120 may have a fixed length and/or a variable length. For instance, in at least one such example, the tether 120 may have a length of 140 meters.

The aerial vehicle 130 may be configured to fly substantially along a closed path 150 to generate electrical energy. The term “substantially along,” as used in this disclosure, refers to exactly along and/or one or more deviations from exactly along that do not significantly impact generation of electrical energy.

The aerial vehicle 130 may include or take the form of various types of devices, such as a kite, a helicopter, a wing and/or an airplane, among other possibilities. The aerial vehicle 130 may be formed of solid structures of metal, plastic and/or other polymers. The aerial vehicle 130 may be formed of any material which allows for a high thrust-to-weight ratio and generation of electrical energy which may be used in utility applications. Additionally, the materials may be chosen to allow for a lightning hardened, redundant and/or fault tolerant design which may be capable of handling large and/or sudden shifts in wind speed and wind direction.

The closed path 150 may be various different shapes in various different embodiments. For example, the closed path 150 may be substantially circular. And in at least one such example, the closed path 150 may have a radius of up to 265 meters. The term “substantially circular,” as used in this disclosure, refers to exactly circular and/or one or more deviations from exactly circular that do not significantly impact generation of electrical energy as described herein. Other shapes for the closed path 150 may be an oval, such as an ellipse, the shape of a jelly bean, the shape of the number of 8, etc.

The aerial vehicle 130 may be operated to travel along one or more revolutions of the closed path 150.

### B. Illustrative Components of an AWT

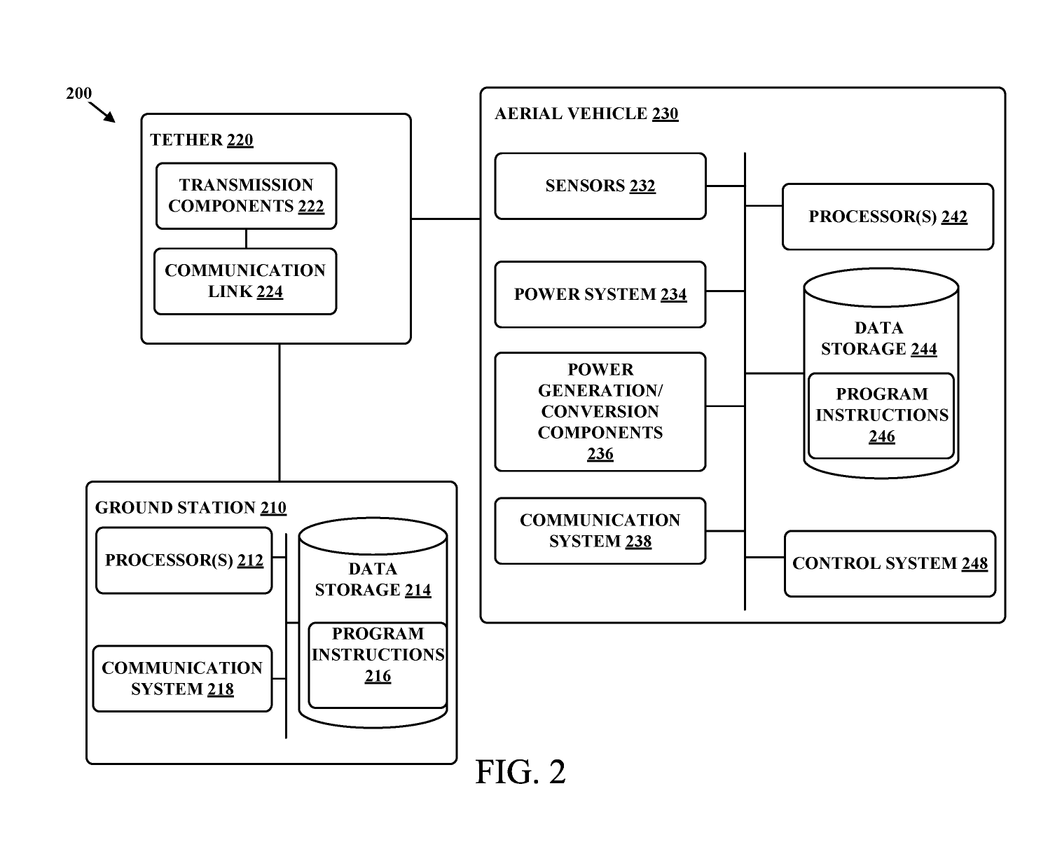

FIG. 2 is a simplified block diagram illustrating components of the AWT 200. The AWT 100 may take the form of or be similar in form to the AWT 200. In particular, the AWT 200 includes a ground station 210, a tether 220, and an aerial vehicle 230. The ground station 110 may take the form of or be similar in form to the ground station 210, the tether 120 may take the form of or be similar in form to the tether 220, and the aerial vehicle 130 may take the form of or be similar in form to the aerial vehicle 230.

As shown in FIG. 2, the ground station 210 may include one or more processors 212, data storage 214, and program instructions 216. A processor 212 may be a general-purpose processor or a special purpose processor (e.g., digital signal processors, application specific integrated circuits, etc.). The one or more processors 212 can be configured to execute computer-readable program instructions 216 that are stored in a data storage 214 and are executable to provide at least part of the functionality described herein.

The data storage 214 may include or take the form of one or more computer-readable storage media that may be read or accessed by at least one processor 212. The one or more computer-readable storage media can include volatile and/or non-volatile storage components, such as optical, magnetic, organic or other memory or disc storage, which may be integrated in whole or in part with at least one of the one or more processors 212. In some embodiments, the data storage 214 may be implemented using a single physical device (e.g., one optical, magnetic, organic or other memory or disc storage unit), while in other embodiments, the data storage 214 can be implemented using two or more physical devices.

As noted, the data storage 214 may include computer-readable program instructions 216 and perhaps additional data, such as diagnostic data of the ground station 210. As such, the data storage 214 may include program instructions to perform or facilitate some or all of the functionality described herein.

In a further respect, the ground station 210 may include a communication system 218. The communication system 218 may include one or more wireless interfaces and/or one or more wireline interfaces, which allow the ground station 210 to communicate via one or more networks. Such wireless interfaces may provide for communication under one or more wireless communication protocols, such as Bluetooth, WiFi (e.g., an IEEE 802.11 protocol), Long-Term Evolution (LTE), WiMAX (e.g., an IEEE 802.16 standard), a radio-frequency ID (RFID) protocol, near-field communication (NFC), and/or other wireless communication protocols. Such wireline interfaces may include an Ethernet interface, a Universal Serial Bus (USB) interface, or similar interface to communicate via a wire, a twisted pair of wires, a coaxial cable, an optical link, a fiber-optic link, or other physical connection to a wireline network. The ground station 210 may communicate with the aerial vehicle 230, other ground stations, and/or other entities (e.g., a command center) via the communication system 218.

In an example embodiment, the ground station 210 may include communication systems 218 that allows for both short-range communication and long-range communication. For example, the ground station 210 may be configured for short-range communications using Bluetooth and for long-range communications under a CDMA protocol. In such an embodiment, the ground station 210 may be configured to function as a “hot spot”; or in other words, as a gateway or proxy between a remote support device (e.g., the tether 220 the aerial vehicle 230, and other ground stations) and one or more data networks, such as cellular network and/or the Internet. Configured as such, the ground station 210 may facilitate data communications that the remote support device would otherwise be unable to perform by itself.

For example, the ground station 210 may provide a WiFi connection to the remote device, and serve as a proxy or gateway to a cellular service provider's data network, which the ground station 210 might connect to under an LTE or a 3G protocol, for instance. The ground station 210 could also serve as a proxy or gateway to other ground stations or a command center, which the remote device might not be able to otherwise access.

Moreover, as shown in FIG. 2, the tether 220 may include transmission components 222 and a communication link 224. The transmission components 222 may be configured to transmit electrical energy from the aerial vehicle 230 to the ground station 210 and/or transmit electrical energy from the ground station 210 to the aerial vehicle 230. The transmission components 222 may take various different forms in various differ embodiments. For example, the transmission components 222 may include one or more conductors that are configured to transmit electricity. And in at least one such example, the one or more conductors may include aluminum and/or any other material which allows for the conduction of electric current. Moreover, in some implementations, the transmission components 222 may surround a core of the tether 220 (not shown).

The ground station 210 could communicate with the aerial vehicle 230 via the communication link 224. The communication link 224 may be bidirectional and may include one or more wired and/or wireless interfaces. Also, there could be one or more routers, switches, and/or other devices or networks making up at least a part of the communication link 224.

Further, as shown in FIG. 2, the aerial vehicle 230 may include one or more sensors 232, a power system 234, power generation/conversion components 236, communication system 238, one or more processors 242, data storage 244, program instructions 246, and a control system 248.

The sensors 232 could include various different sensors in various different embodiments. For example, the sensors 232 may include a global positioning system (GPS) receiver. The GPS receiver may be configured to provide data that is typical of well-known GPS systems (which may be referred to as a global navigation satellite system (GNNS)), such as the GPS coordinates of the aerial vehicle 230. Such GPS data may be utilized by the AWT 200 to provide various functions described herein.

As another example, the sensors 232 may include one or more wind sensors, such as one or more pitot tubes. The one or more wind sensors may be configured to detect apparent and/or relative wind. Such wind data may be utilized by the AWT 200 to provide various functions described herein.

Still as another example, the sensors 232 may include an inertial measurement unit (IMU). The IMU may include both an accelerometer and a gyroscope, which may be used together to determine the orientation of the aerial vehicle 230. In particular, the accelerometer can measure the orientation of the aerial vehicle 230 with respect to earth, while the gyroscope measures the rate of rotation around an axis, such as a centerline of the aerial vehicle 230. IMUs are commercially available in low-cost, low-power packages. For instance, the IMU may take the form of or include a miniaturized MicroElectroMechanical System (MEWS) or a NanoElectroMechanical System (NEMS). Other types of IMUs may also be utilized. The IMU may include other sensors, in addition to accelerometers and gyroscopes, which may help to better determine position. Two examples of such sensors are magnetometers and pressure sensors. Other examples are also possible.

While an accelerometer and gyroscope may be effective at determining the orientation of the aerial vehicle 230, slight errors in measurement may compound over time and result in a more significant error. However, an example aerial vehicle 230 may be able mitigate or reduce such errors by using a magnetometer to measure direction. One example of a magnetometer is a low-power, digital 3-axis magnetometer, which may be used to realize an orientation independent electronic compass for accurate heading information. However, other types of magnetometers may be utilized as well.

The aerial vehicle 230 may also include a pressure sensor or barometer, which can be used to determine the altitude of the aerial vehicle 230. Alternatively, other sensors, such as sonic altimeters or radar altimeters, can be used to provide an indication of altitude, which may help to improve the accuracy of and/or prevent drift of the IMU. In addition, the aerial vehicle 230 may include one or more load cells configured to detect forces distributed between a connection of the tether 220 to the aerial vehicle 230.

As noted, the aerial vehicle 230 may include the power system 234. The power system 234 could take various different forms in various different embodiments. For example, the power system 234 may include one or more batteries for providing power to the aerial vehicle 230. In some implementations, the one or more batteries may be rechargeable and each battery may be recharged via a wired connection between the battery and a power supply and/or via a wireless charging system, such as an inductive charging system that applies an external time-varying magnetic field to an internal battery and/or charging system that uses energy collected from one or more solar panels.

As another example, the power system 234 may include one or more motors or engines for providing power to the aerial vehicle 230. In some implementations, the one or more motors or engines may be powered by a fuel, such as a hydrocarbon-based fuel. And in such implementations, the fuel could be stored on the aerial vehicle 230 and delivered to the one or more motors or engines via one or more fluid conduits, such as piping. In some implementations, the power system 234 may be implemented in whole or in part on the ground station 210.

As noted, the aerial vehicle 230 may include the power generation/conversion components 236. The power generation/conversion components 236 could take various different forms in various different embodiments. For example, the power generation/conversion components 236 may include one or more generators, such as high-speed, direct-drive generators. With this arrangement, the one or more generators may be driven by one or more rotors. And in at least one such example, the one or more generators may operate at full rated power wind speeds of 11.5 meters per second at a capacity factor which may exceed 60 percent, and the one or more generators may generate electrical power from 40 kilowatts to 600 kilowatts.

Moreover, as noted, the aerial vehicle 230 may include a communication system 238. The communication system 238 may take the form of or be similar in form to the communication system 218. The aerial vehicle 230 may communicate with the ground station 210, other aerial vehicles, and/or other entities (e.g., a command center) via the communication system 238.

In some implementations, the aerial vehicle 230 may be configured to function as a “hot spot”; or in other words, as a gateway or proxy between a remote support device (e.g., the ground station 210, the tether 220, other aerial vehicles) and one or more data networks, such as cellular network and/or the Internet. Configured as such, the aerial vehicle 230 may facilitate data communications that the remote support device would otherwise be unable to perform by itself.

For example, the aerial vehicle 230 may provide a WiFi connection to the remote device, and serve as a proxy or gateway to a cellular service provider's data network, which the aerial vehicle 230 might connect to under an LIE or a 3G protocol, for instance. The aerial vehicle 230 could also serve as a proxy or gateway to other aerial vehicles or a command station, which the remote device might not be able to otherwise access.

As noted, the aerial vehicle 230 may include the one or more processors 242, the program instructions 246, and the data storage 244. The one or more processors 242 can be configured to execute computer-readable program instructions 246 that are stored in the data storage 244 and are executable to provide at least part of the functionality described herein. The one or more processors 242 may take the form of or be similar in form to the one or more processors 212, the data storage 244 may take the form of or be similar in form to the data storage 214, and the program instructions 246 may take the form of or be similar in form to the program instructions 216.

Moreover, as noted, the aerial vehicle 230 may include the control system 248. In some implementations, the control system 248 may be configured to perform one or more functions described herein. The control system 248 may be implemented with mechanical systems and/or with hardware, firmware, and/or software. As one example, the control system 248 may take the form of program instructions stored on a non-transitory computer readable medium and a processor that executes the instructions. The control system 248 may be implemented in whole or in part on the aerial vehicle 230 and/or at least one entity remotely located from the aerial vehicle 230, such as the ground station 210. Generally, the manner in which the control system 248 is implemented may vary, depending upon the particular application.

While the aerial vehicle 230 has been described above, it should be understood that the methods and systems described herein could involve any suitable aerial vehicle that is connected to a tether, such as the tether 220 and/or the tether 120.

### C. Illustrative Aerial Vehicle

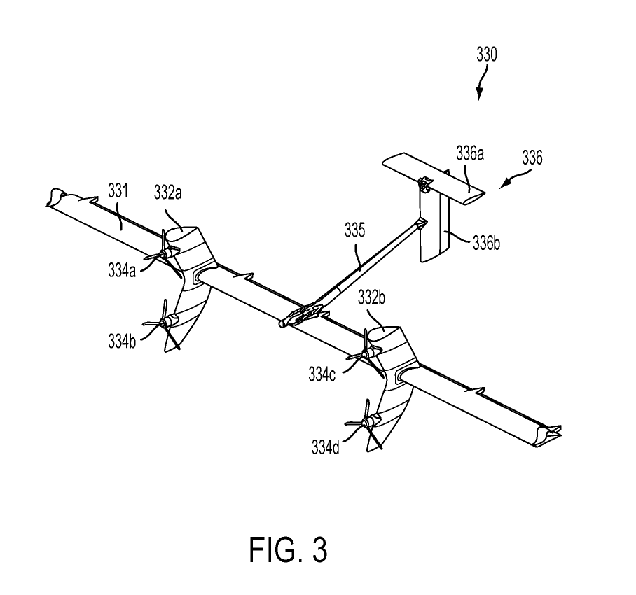

FIG. 3 depicts an aerial vehicle 330, according to an example embodiment. The aerial vehicle 130 and/or the aerial vehicle 230 may take the form of or be similar in form to the aerial vehicle 330. In particular, the aerial vehicle 330 may include a main wing 331, pylons 332a, 332b, rotors 334a, 334b, 334c, 334d, a tail boom 335, and a tail wing assembly 336. Any of these components may be shaped in any form which allows for the use of components of lift to resist gravity and/or move the aerial vehicle 330 forward.

The main wing 331 may provide a primary lift force for the aerial vehicle 330. The main wing 331 may be one or more rigid or flexible airfoils, and may include various control surfaces, such as winglets, flaps (e.g., Fowler flaps, Hoerner flaps, split flaps, and the like), rudders, elevators, spoilers, dive brakes, etc. The control surfaces may be used to stabilize the aerial vehicle 330 and/or reduce drag on the aerial vehicle 330 during hover flight, forward flight, and/or crosswind flight.

The main wing 331 and pylons 332a, 332b may be any suitable material for the aerial vehicle 330 to engage in hover flight, forward flight, and/or crosswind flight. For example, the main wing 331 and pylons 332a, 332b may include carbon fiber and/or e-glass, and include internal supporting spars or other structures. Moreover, the main wing 331 and pylons 332a, 332b may have a variety of dimensions. For example, the main wing 331 may have one or more dimensions that correspond with a conventional wind turbine blade. As another example, the main wing 331 may have a span of 8 meters, an area of 4 meters squared, and an aspect ratio of 15.

The pylons 332a, 332b may connect the rotors 334a, 334b, 334c, and 334d to the main wing 331. In some examples, the pylons 332a, 332b may take the form of, or be similar in form to, a lifting body airfoil (e.g., a wing). In some examples, a vertical spacing between corresponding rotors rotor 334a and rotor 334b on pylon 332a) may be 0.9 meters.

The rotors 334a, 334b, 334c, and 334d may be configured to drive one or more generators for the purpose of generating electrical energy. In this example, the rotors 334a, 334b, 334c, and 334d may each include one or more blades, such as three blades or four blades. The rotor blades may rotate via interactions with the wind and be used to drive the one or more generators. In addition, the rotors 334a, 334b, 334c, and 334d may also be configured to provide thrust to the aerial vehicle 330 during flight. With this arrangement, the rotors 334a, 334b, 334c, and 334d may function as one or more propulsion units, such as a propeller. Although the rotors 334a, 334b, 334c, and 334d are depicted as four rotors in this example, in other examples the aerial vehicle 330 may include any number of rotors, such as less than four rotors or more than four rotors (e.g., eight rotors).

A tail boom 335 may connect the main wing 331 to the tail wing assembly 336, which may include a tail wing 336a and a vertical stabilizer 336b. The tail boom 335 may have a variety of dimensions. For example, the tail boom 335 may have a length of 2 meters. Moreover, in some implementations, the tail boom 335 could take the form of a body and/or fuselage of the aerial vehicle 330. In such implementations, the tail boom 335 may carry a payload.

The tail wing 336a and/or the vertical stabilizer 336b may be used to stabilize the aerial vehicle 330 and/or reduce drag on the aerial vehicle 330 during hover flight, forward flight, and/or crosswind flight. For example, the tail wing 336a and/or the vertical stabilizer 336b may be used to maintain a pitch of the aerial vehicle 130 during hover flight, forward flight, and/or crosswind flight. The tail wing 336a and the vertical stabilizer 336b may have a variety of dimensions. For example, the tail wing 336a may have a length of 2 meters. Moreover, in some examples, the tail wing 336a may have a surface area of 0.45 meters squared. Further, in some examples, the tail wing 336a may be located 1 meter above a center of mass of the aerial vehicle 130.

While the aerial vehicle 330 has been described above, it should be understood that the systems described herein could involve any suitable aerial vehicle that is connected to an airborne wind turbine tether, such as the tether 120 and/or the tether 220.

### D. Aerial Vehicle Coupled to a Ground Station Via a Tether

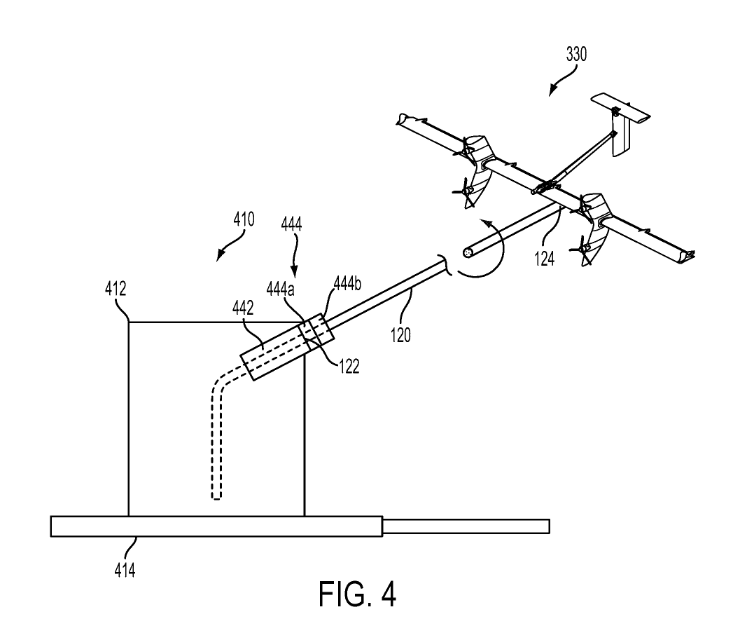

FIG. 4 depicts the aerial vehicle 330 coupled to a ground station 510 via the tether 120. Referring to FIG. 4, the ground station 410 may include a winch drum 412 and a platform 414. The ground station 110 and/or the ground station 210 may take the form of or be similar in form to the ground station 410. FIG. 4 is for illustrative purposes only and may not reflect all components or connections.

As shown in FIG. 4, the tether 120 may be coupled to a tether gimbal assembly 442 at a proximate tether end 122 and to the aerial vehicle 330 at a distal tether end 124. Additionally or alternatively, at least a portion of the tether 120 (e.g., the at least one insulated electrical conductor) may pass through the tether gimbal assembly 442. In some embodiments, the tether 120 may terminate at the tether gimbal assembly 442. Moreover, as shown in FIG. 4, the tether gimbal assembly 442 may also be coupled to the winch drum 412 which in turn may be coupled to the platform 414. In some embodiments, the tether gimbal assembly 442 may be configured to rotate about one or more axes, such as an altitude axis and an azimuth axis, in order to allow the proximate tether end 122 to move in those axes in response to movement of the aerial vehicle 330.

A rotational component 444 located between the tether 120 and the tether gimbal assembly 442 may allow the tether 120 to rotate about the long axis of the tether 120. The long axis is defined as extending between the proximate tether end 122 and the distal tether end 124. In some embodiments, at least a portion of the tether 120 may pass through the rotational component 444. Moreover, in some embodiments, the tether 120 may pass through the rotational component 444. Further, in some embodiments, the rotational component 444 may include a fixed portion 444a and a rotatable portion 444b, for example, in the form of one or more bearings and/or slip rings. The fixed portion 444a may be coupled to the tether gimbal assembly 442. The rotatable portion 444b may be coupled to the tether 120.

The use of the word fixed in the fixed portion 444a of the rotational component 444 is not intended to limit fixed portion 444a to a stationary configuration. In this example, the fixed portion 444a may move in axes described by the tether gimbal assembly 442 (e.g., altitude and azimuth), and may rotate about the ground station 410 as the winch drum 412 rotates, but the fixed portion 444a will not rotate about the tether 120, i.e., with respect to the long axis of the tether 120. Moreover, in this example, the rotatable portion 444b of the rotational component 444 may be coupled to the tether 120 and configured to substantially rotate with the rotation of tether 120.

Via the rotational component 444, the tether 120 may rotate about its centerline along the long axis as the aerial vehicle 330 orbits. The distal tether end 124 may rotate a different amount than the proximate tether end 122, resulting in an amount of twist along the length of the tether 420. With this arrangement, the amount of twist in the tether 420 may vary based on a number of parameters during crosswind flight of the aerial vehicle 330.

### E. Illustrative Bridles and Bridle Systems

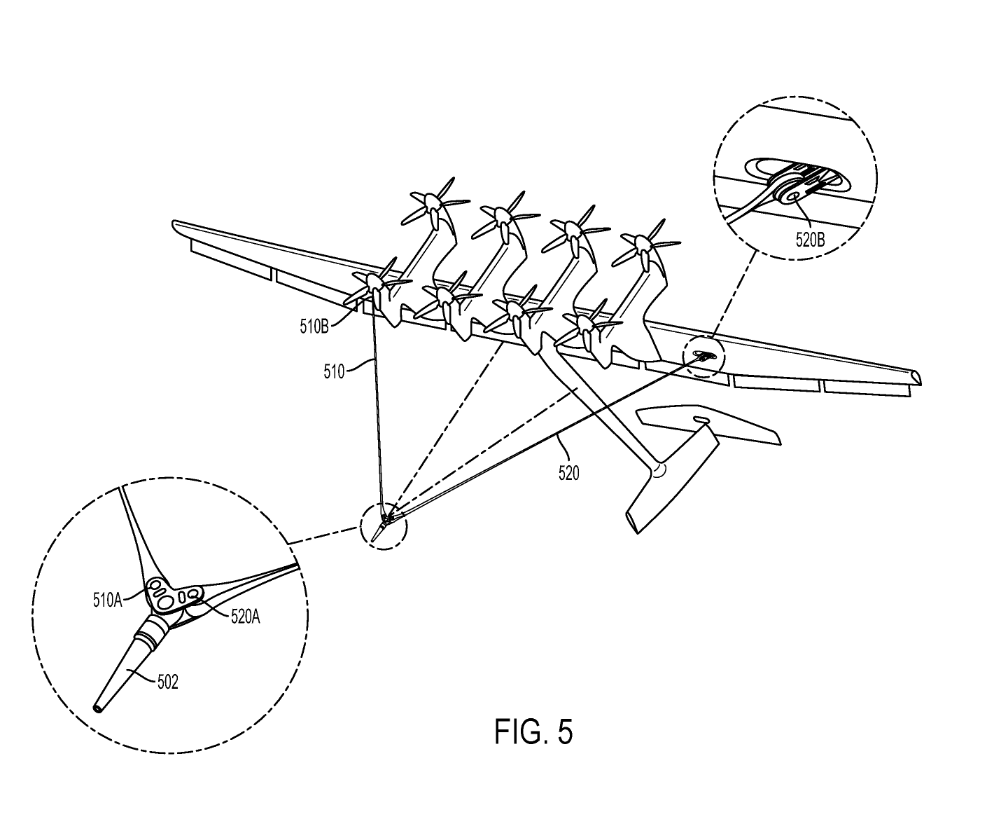

FIG. 5 depicts the aerial vehicle 330 coupled to the tether 120 via a bridle system 500. FIG. 5 and the remaining Figures depicting bridles and bridle systems are for illustrative purposes only and may not reflect all components or connections. Further, as illustrations, the Figures may not reflect actual operating conditions but are merely to illustrate the embodiments described. For example, while a perfectly straight figure may be used to illustrate the described bridle components, during orbiting crosswind flight the tether and/or bridle(s) may in practice exhibit some level of droop between the ground station and the aerial vehicle. Further still, the relative dimensions in the Figures may not be to scale but are merely to illustrate the embodiments described.

As shown in FIG. 5, the bridle system 500 includes a first bridle 510 and a second bridle 520, according to an example embodiment. The bridle system 500 includes a first bridle-to-tether interface 510A and a second bridle-to-tether interface 520A. The bridle system 500 includes a first bridle-to-wing interface 510B and a second bridle-to-wing interface 520B. The bridle system 500 includes a tether termination component 502.

In some implementations, the tether 120 terminates at the tether termination component 502. A double clevis, 2-pin connector may be used as the bridle-to-tether interface for interfaces 510A and 510B. This interface transfers mechanical load from the tether to the bridles, allows for a roll degree-of-freedom, and allows the transfer of power and signal conductors from the tether to the bridles. Other connectors may be used as well (e.g., a double clevis and single pin connector and a 3 pin configuration). In some embodiments, the pins may use wear-resistant and low-friction journal bearings to achieve good roll motion. For example, a journal bearing with a polytetrafluoroethylene (“PTFE”) embedded fabric on a stainless steel backing may be used. In some embodiments, a spherical bearing may be used at the bridle-to-tether interface. Other connectors and examples are possible.

The power and signal transfer may occur, for example, by way of a power transfer loop, cable, or system such as a full or partial service loop that allows roll motion without generating bending fatigue on the conductors. The first bridle 510 and the second bridle 520 may have a structural member composed of wrapping fiber filaments around thimbles (e.g., the clevis pin at the tether-to-bridle interface may go through the bridle thimble). The wrapped fiber filaments may be consolidated and cured into a solid, stiff, and strong link.

As shown in FIG. 5, the length of the bridles may be different. For example, the length of the second bridle 520 from the bridle-to-tether interface 520A to the bridle-to-wing interface 520B may be shorter than the length of the first bridle 510 from the bridle-to-tether interface 510A to the bridle-to-wing interface 510B in order to balance the load during power generation (since the aerial vehicle may be flying in a one-directional path). The electrical conductors (not shown in FIG. 5) may take advantage of this shorter distance (and the nominally smaller loads experienced along the second bridle 520 compared to the loads along the first bridle 510) and only extend along the second bridle 520.

The bridle-to-wing interfaces 510B and 520B may use a spherical bearing to allow low-friction and high-cycle pitch movement. A metal plate installed on the aerial vehicle may act as a clevis and capture the bearing to transfer load in the aerial vehicle (e.g., into the wing spar of the aerial vehicle). In some embodiments, the bridle-to-wing interface may not comprise a spherical bearing. For example, the bridle-to-wing interface may be a saddle-type bearing surface (e.g., links in a chain), a combination of journal and thrust bearings; or two journal bearings joints that serve as a universal joint. Other examples are possible.

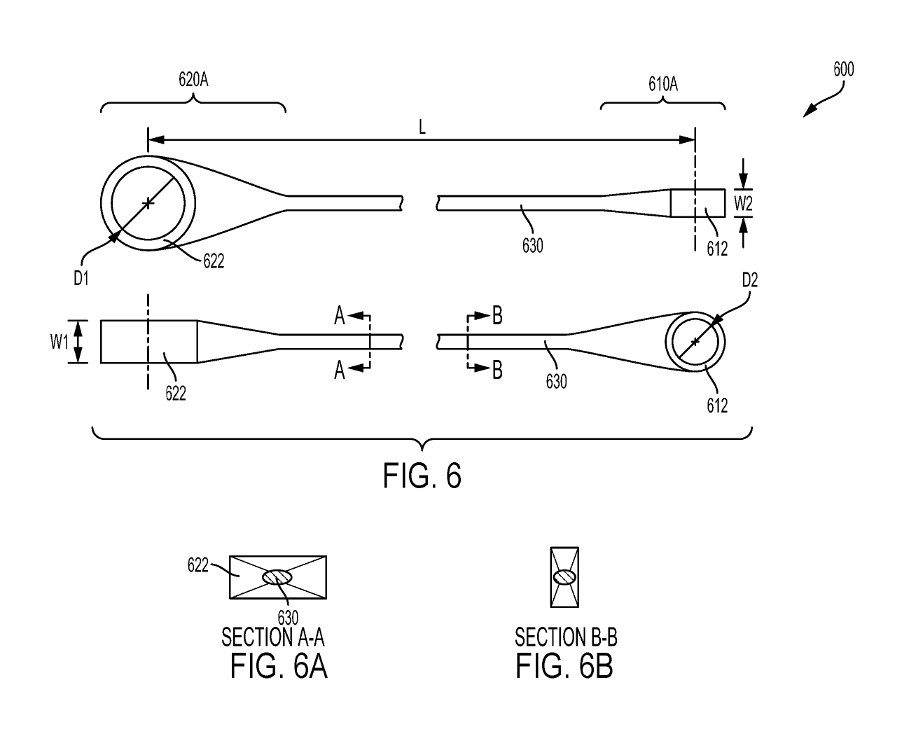

FIG. 6 depicts a bridle 600 in a first orientation and in a second orientation where the bridle 600 is turned 90 degrees from the first orientation, according to an example embodiment. The bridle 600 includes one or more sensors (not shown), bridle-to-tether interface 610A, a tether thimble 612, a bridle-to-wing interface 620A, a wing thimble 620, and a structural member 630. As shown in FIG. 6, the wing thimble and the tether thimble are rotated ninety degrees. In some implementations, the wing thimble and the tether thimble may be rotated more or less than ninety degrees, or may be in phase and not rotated at all.

The structural member 630 may comprise wrapped fiber filaments or a variety of materials. For instance, in some embodiments, the structural member 630 may comprise carbon fiber, glass fiber, dry strength fiber (e.g., aramid, poly(p-phenylene-2,6-benzobisoxazole) (“PBO”), or ultra-high-molecular-weight polyethylene (“UHMW-PE”)), metallic wire, or any other suitable material.

Portions of the bridle that may experience higher loads may be more reinforced than others. For example, as depicted in FIG. 6, the portion of the bridle-to-tether interface 610A that is closest to the tether thimble 612 may have more reinforcement (e.g., a higher number of wrapped fiber filaments) in comparison to the center of the structural member 630. Similarly, the portion of the bridle-to-wing interface 620A that is closest to the wing thimble 622 may have more reinforcement (e.g., a higher number of wrapped fiber filaments) in comparison to the center of the structural member 630.

The dimensions of the bridles and bridle components may be selected based at least in part on a predicted loading of the bridle 600, such as a predicted tensile loading of the bridle 600. For use with AWTs, a first bridle may have a length L of about 7100 millimeters (e.g., the distance from the center of the tether thimble 612 to the center of the wing thimble 622). On the first bridle, the tether thimble 612 may have an inside diameter D2 of about 62 millimeters and a width W2 of about 57 millimeters. On the first bridle, the wing thimble 622 may have an inside diameter D1 of about 120 millimeters and a width W1 of about 45 millimeters. A second bridle may have a length L of about 7880 millimeters. The second bridle may have a tether thimble 612 with an inside diameter D2 of about 62 millimeters and a width W2 of about 57 millimeters. The second bridle may have a wing thimble 622 with an inside diameter D1 of about 120 millimeters and a width W1 of about 45 millimeters.

The bridle system 600 may include one or more sensors (not shown). The sensors may be placed on the terminations (e.g., the bridle-to-tether interface 610A and the bridle-to-wing interface 620A), or the sensors could be placed elsewhere in the bridle 600, in the tether 120, or the aerial vehicle 330. In some embodiments, the bridle system 600 may be designed to measure loads or positions. For example, the bridle system 600 may include a sensor such as an embedded fiber-bragg strain-sensing fiber optic, a one-directional load pin at a bridle end, a bidirectional load pin at a bridle end, or a direct strain gage coupled to the bridle-to-wing interface 620A.

FIGS. 6A and 6B depict the bridle 600 in cross-section along the lines AA and BB in FIG. 6, according to an example embodiment. As shown in FIGS. 6A and 6B, the structural member 630 may have an approximately elliptical shape in cross-section. In some implementations, the oval aspect ratio is about 2:1. As shown in FIG. 6A, the structural member 630 cross-section is in phase with the wing thimble 622. As shown in FIG. 6B, the structural member 630 is still in phase with the wing thimble, but is 90 degrees out of phase with the tether thimble 612. By providing a 90 degree phase difference between the tether thimble 612 and the wing thimble 622, the tether thimble 612 may be aligned with a roll axis to allow for roll motions, and the wing thimble 622 may be aligned with a pitch axis to allow for pitch motions. Further, having the cross-section of the structural member 630 in phase with the wing thimble 622 minimizes drag on the bridle 600. While FIGS. 6A and 6B depict an elliptical cross-section of the structural member 630, the cross-section may have various shapes, such as a circle or an aerofoil shape, among others.

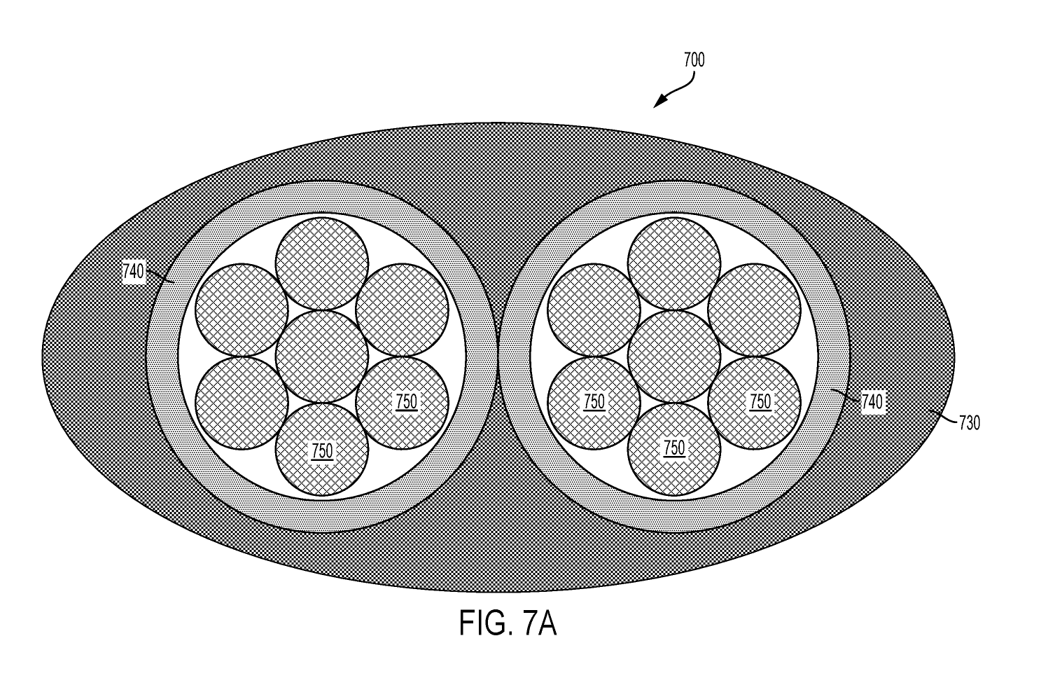

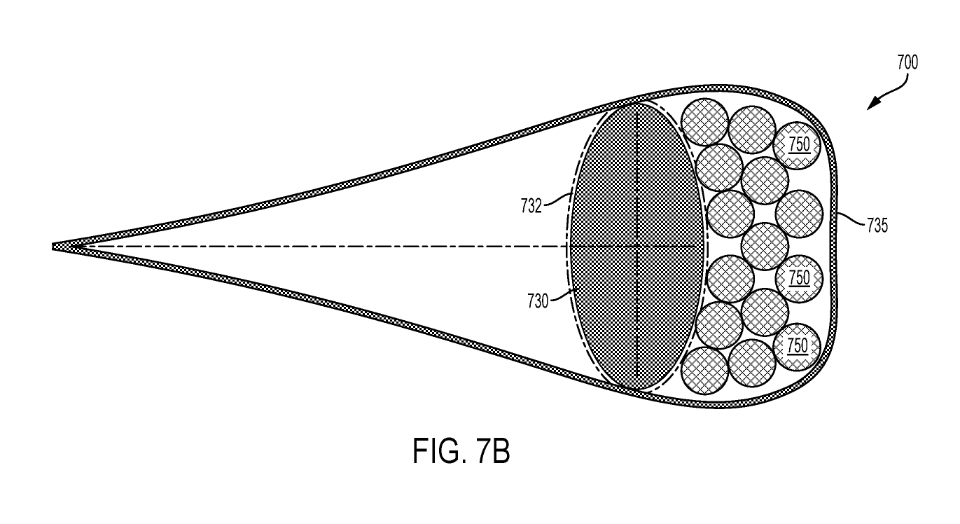

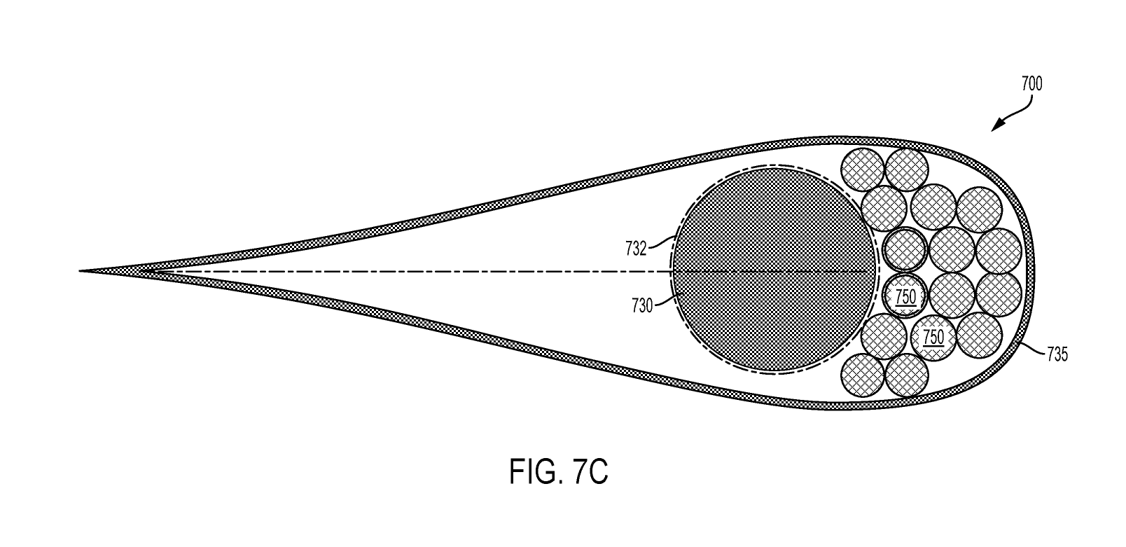

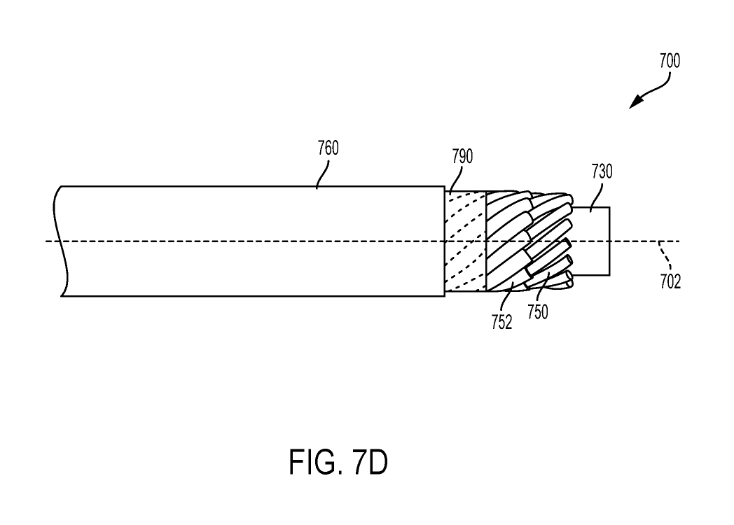

FIGS. 7A, 7B, 7C, and 7D depict example implementations for placing conductors in or around the bridle, according to some embodiments. FIG. 7A depicts a bridle 700 with a structural member 730, two hollow tubes 740, and conductors 750. The conductors 750 may be insulated or bare. In some implementations, one or more hollow tubes may be configured inside of the structural member 730. Conductors 750 may run through the hollow tubes 740 and extend throughout the bridle 700.

In other implementations, the conductors 750 may be connected in other ways. For example, the conductors 750 may be connected to the wing along a path that is separate from the bridles. In some embodiments, the conductors (and other components) may run on the only one bridle. In other embodiments, the conductors (and other components) may be split between two or more bridles. In some embodiments, the conductors are run on the outside of the bridle in a straight line. In some embodiments, the conductors are helically wrapped around the structural member of the bridle. In some embodiments, the conductors are tacked to the structural member in several places but have slack between those spots so the structural member can be loaded without straining the conductors. In some embodiments, each conductor on a bridle is matched with a conductor on the tether. In other embodiments, conductors on the bridle may be combined such that the bridle has fewer conductors than the tether (e.g., conductors within a phase may be combined).

FIG. 7B depicts a bridle 700 with an elliptically shaped structural member 730, a fairing component 735, and conductors 750. As shown in FIG. 7B, the bridle 700 may include a fairing component 735 that couples to the structural member 730 to provide a more aerodynamic shape for the structural member 730 and conductors 750. The structural member 730 may be surrounded by a layer of compliant material 732 with an elastic modulus higher than that of the structural member 730. The compliant material 732 may protect the conductors 750 from abrasion caused by friction against the structural member 730 and from the full axial strains of the structural member 730. A bridle may be faired in some or all parts, including along the main length of the structural member 730 and at the terminations (e.g., the bridle-to-wing interface and the bridle-to-tether interface). The fairing could comprise a “V” shape that is added to a round or elliptical main cross-section, or the main section itself may be molded into an aerodynamic shape. Fairing design includes a proper positioning of the center of gravity, elastic center, and the aerodynamic center such that the bridle will be stable at all flights speeds and not flutter.

To mitigate flutter, the conductors 750 may run along the leading edge of the bridle 700 so that the center of mass of the bridle 700 is placed in such a way that the faired bridle is stable. The fairing component 735 may be a non-structural component that is added around all or part of the bridle 700 to lower the drag and/or pull back the aerodynamic center of the bridle 700 cross-section for stability and to resist flutter. The cross-section of the structural core may be elliptically shaped where the minor axis is aligned with the airflow. This alignment provides more width to fit the conductors 750 neatly in front of the structural member 730 and shortens the amount of total fairing needed, which in turn allows the bridle 700 to be more tolerant of high angles between the oncoming air or relative wind and a reference line on the bridle 700. The fairing component 735 may be designed to fit around the bridle 700 such that it can rotate and “vane” into the wind to help achieve a proper orientation. In some embodiments, where wind direction is expected to remain substantially constant along the length of the bridle 700, the fairing component 735 may be affixed to the structural member 730 in alignment with the airflow such that it cannot rotate or “vane.”

In some implementations, the fairing may have a profile that not only reduces drag (e.g., via boundary tripping features) in one direction, but has a low drag and/or low lift when the angle of attack is at higher angles. The major axis of the fairing may be angled slightly to help match the typical direction of the local relative airflow (instead of being aligned perpendicular to the wing axis). In some implementations, the angle of the major axis of the fairing may vary along the length of the bridle 700.

In some implementations, bridle 700 may have surface features that trips the boundary layer for lower overall drag. For example, the bridle 700 may have riblets, grooves, vortex generators, dibbles, or other boundary layer tripping features. In some implementations, bridle 700 may have surface features that provide leading edge protection, such as a polyurethane elastomer or any other material that may provide leading edge wind protection.

FIG. 7C depicts a bridle 700 with a circular structural member 730, a fairing component 735, and conductors 750. As shown in FIG. 7C, the bridle 700 may include a fairing component 735 that couples to the structural member 730 to provide a more aerodynamic shape for the structural member 730 and conductors 750. The conductors 750 may run along the leading edge of the bridle 700 so that the center of mass of the bridle 700 is placed in such a way that the faired bridle is stable and won't flutter. The fairing component 735 may be a non-structural component that is added around all or part of the bridle 700 to lower the drag and/or pull the aerodynamic center of the bridle 700 cross-section for stability and to resist flutter.

FIG. 7D depicts conductors 750 helically wrapped about a structural member 730 of a bridle 700. As shown in FIG. 7D, the bridle 700 may include a structural member 730, a plurality of electrical conductors 750, and a jacket 760. The bridle 700 may have a long axis 702. For purposes of illustration only, the bridle 700 in FIG. 7D is shown with a portion of some components removed (e.g., the jacket 760 and the plurality of electrical conductors 750) to illustrate the arrangement of components in the bridle 700. Accordingly, FIG. 7D may be referred to as a partial cutaway view of the bridle 700.

The structural member 730 may be wrapped fiber filaments that have been consolidated and cured as described herein. In some embodiments, the structural member 730 may provide a significant contribution to the tensile strength and/or shear strength of the bridle 700. Beneficially, the structural member 730 may improve resistance of the bridle 700 to fatigue loads while an AWT (e.g., the AWT 100 and/or AWT 200) is in operation. Further, the structural member 730 may improve resistance of various components of the bridle 700 to fatigue or tensile loads, such as the plurality of electrical conductors 750.

The structural member 730 may take various different forms in various different embodiments. For example, in some embodiments, the structural member 730 may comprise pultruded fiber rod, carbon fiber rod, fiberglass, one or more metals (e.g., aluminum), a combination of carbon fiber, fiberglass, and/or one or more metals, and/or resins or thermoplastics. As one example, the structural member 730 may comprise a combination of fibers, such as a first carbon fiber having a first modulus and second carbon fiber having a second modulus that is greater than the first modulus. As another example, the structural member 730 may comprise carbon fiber and fiberglass. Further, the structural member 730 may comprise a matrix composite and/or carbon fiber and/or fiberglass, such as a metal matrix composite (e.g., aluminum matrix composite).

In some embodiments, the structural member 730 may have a circular cross-section shape or may comprise other cross-section shapes. For example, in some embodiments, the structural member 730 may have an elliptical shape (e.g., with an aspect ratio of about 2:1), a trapezoidal cross-section shape, a pie-wedge cross-section shape, a rectangular cross-section shape, a triangular cross-section shape, etc. In some embodiments, the structural member 730 may comprise a plurality of smaller structural members with various cross-section shapes. In addition, in some embodiments, the structural member 730 may have a cross-section shape that varies along the long axis 702 of the bridle 700.

Further, the plurality of electrical conductors 750 may be configured to transmit electricity. For example, the plurality of electrical conductors 750 may be configured for high-voltage AC or DC power transmission e.g., greater than 1,000 volts). For instance, the plurality of electrical conductors 750 may be configured to carry an AC or DC voltage of between 1 kilovolt and 5 kilovolts, or higher, and an associated power transmission current of between 50 amperes to 250 amperes.

In some embodiments, as shown in FIG. 7D, the plurality of electrical conductors 750 may be helically wound around the outer surface of the structural member 730. The plurality of electrical conductors 750 may be wound in other ways. For example, in some embodiments, electrical conductors in the plurality of electrical conductors 750 may have an alternating arrangement around the outer surface of the structural member 730, or a reverse oscillating lay around the outer surface of the structural member 730.

In some embodiments, the plurality of electrical conductors 750 may include groups of electrical conductors that define separate electrical paths. Further, in some embodiments, the groups of electrical conductors may be configured to operate differently. For instance, in an AC power transmission arrangement, a first group of electrical conductors may be configured to carry a first phase of electrical power along a first electrical path, a second group of electrical conductors may be configured to carry a second phase of electrical power along a second electrical path that is different from the first phase of electrical power, and so on. Moreover, in a DC power transmission arrangement, a first group of electrical conductors may be configured to operate at a first potential along a first electrical path, a second group of electrical conductors may be configured to operate at a second potential along a second electrical path that is different from the first potential, and so on. As one example, the first potential may be +2000 volts relative to ground, and the second potential may be −2000 volts relative to ground. As another example, the first potential may be a high voltage, and the second potential may be near ground potential.

In some embodiments, each electrical conductor of the plurality of electrical conductors 750 may comprise the same material and have the same thickness. However, in some embodiments, at least two electrical conductors of the plurality of electrical conductors 750 may comprise different materials and/or have different thicknesses. For example, in some embodiments, an electrical conductor in the first group of electrical conductors that is adjacent to an electrical conductor in the second group of electrical conductors may have a different thickness than an electrical conductor in the first group of electrical conductors that is adjacent to two electrical conductors in the first group of electrical conductors.

In some embodiments, the electrical conductors 750 may be relieved of strain by winding at a helical angle that is steep or far from the bridle axis. The electrical conductors 750 may additionally be relieved of strain by inclusion of a low bulk modulus layer within the winding radius of the electrical conductors 750, such that the low bulk modulus layer compresses under the tension of the electrical conductors 750, allowing some inward radial travel of the electrical conductors 750, and thus reduces the required free length of the electrical conductors 750.

Moreover, in some embodiments, each electrical conductor of the plurality of electrical conductors 750 may include an insulating layer 752. However, in other embodiments, at least one electrical conductor of the plurality of electrical conductors 750 may not include an insulating layer.

In some embodiments, the bridle 700 may further include a fill material 790 located between the conductors 750 and the jacket 760, such that the fill material 790 fills the interstices. With this arrangement, the fill material 790 may block moisture from the plurality of electrical conductors 750. For instance, in some embodiments, the fill material 790 may block moisture from diffusing inside of the bridle 700 along the plurality of electrical conductors 750.

Fill material 790 may take various different forms in various different embodiments. For instance, in some embodiments, the fill material 790 may include a vulcanizing rubber on silicone, such as a room-temperature vulcanizing rubber. In addition, the fill material 790 may include mylar. Further, in some such embodiments, the fill material 790 may comprise one or more filler rods, fibers, and/or tapes.

The jacket 760 may take various different forms in various different embodiments. For instance, the jacket 760 may include a thermoplastic polyurethane (“TPU”), polypropylene, hytrel, and/or nylon (e.g., nylon 11). In some embodiments, the jacket 760 may be extruded over the plurality of electrical conductors 750. Moreover, in some embodiments, when the bridle 700 includes the fill material 790, the jacket 760 may be extruded over the fill material 790. Further, in some embodiments, the jacket 760 may have a preferred thickness of 1.2 or 1.5 millimeters. Other thicknesses are possible as well.

In some embodiments, one or more materials of the jacket 760 may be selected to increase the visibility of the bridle 700 to humans and/or animals. For instance, in some embodiments, the jacket 760 may include materials that have a white or bright color, or a contrasting color pattern. Further, in some embodiments, the jacket 760 may include a material or coating that reflects ultra-violet (UV) light, glows, or a combination of UV reflection and glowing.

Further, in some examples, the bridle 700 may further include at least one fiber optic cable and/or a coaxial conductor (not shown). The fiber optic cable or coaxial conductor may be configured for communication between an aerial vehicle (e.g., the aerial vehicle 330) and a ground station (e.g., the ground station 410 via the tether 120). In some embodiments, the fiber optic cable or coaxial cable may be wound around the outer surface structural member 730 in the same or similar way as the plurality of electrical conductors 750 are wound. Yet further, in some examples, the bridle 700 may further include conductors configured to communicate via Ethernet over power (“EOP”).

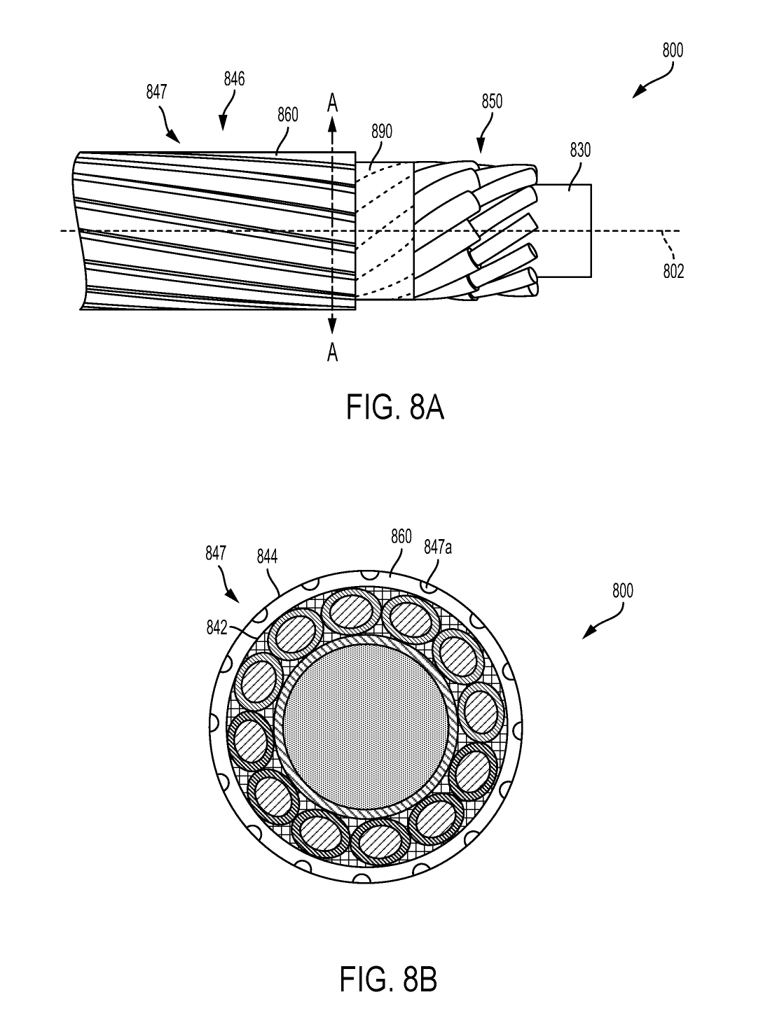

In some implementations, a bridle may include a jacket that has a plurality of drag-affecting surface features (e.g., features that trip the boundary layer). FIG. 8A depicts a bridle 800, according to an example embodiment. Further, FIG. 8B depicts the bridle 800 in cross-section along line AA, according to an example embodiment. For purposes of illustration only, the bridle 800 in FIG. 8A is shown with a portion of some components removed in the same way as the bridle 700 in FIG. 7D.

As shown in FIG. 8A, the bridle 800 may include, among other components, a structural member 830, a plurality of electrical conductors 850, a jacket 860, and a fill material 890. Components in FIGS. 8A and 8B similar to those in FIG. 7D may be of the same configuration and function in a similar manner.

The jacket 860 may include an inner surface 842 that covers at least a portion of the plurality of electrical conductors 830 and an outer surface 844 opposite the inner surface 842. The outer surface 844 of the jacket 860 may comprise a plurality of drag-affecting surface features 846. The plurality of drag-affecting surface features 846 may be configured to affect drag of the bridle 800. As one example, the plurality of drag-affecting surface features 846 may reduce the drag of the bridle 800. As another example, the plurality of drag-affecting surface features 846 may increase the drag of the bridle 800.

The plurality of drag-affecting surface features 846 may take various different forms in various different embodiments. In some embodiments, the plurality of drag-affecting surface features 846 may comprise a plurality of flutes 847 (e.g., grooves) in the outer surface 844 of the jacket 860. As shown in FIG. 8B, in some embodiments, the plurality of flutes 847 may include sixteen flutes having a pitch of 500 millimeters (flute 847a of the plurality of flutes 847 labeled in FIG. 8B). However, in other embodiments, the plurality of flutes 847 may include more or less than sixteen flutes and/or the plurality of flutes 847 may have a different pitch. In addition, in some embodiments, each flute of the plurality of flutes 847 may have the same depth and same radius. However, in other embodiments, at least two flutes of the plurality of flutes 847 may have a different depth and/or a different radius. As one example, flute 847a may have a depth of 0.6 millimeters and a radius of 0.8 millimeters.

Moreover, in some embodiments, the plurality of drag-affecting surface features 846 may include a plurality of strakes (e.g., ridges) protruding from the outer surface 844 of the jacket 860, a plurality of dimples, tape with riblets, or any other textured shape/material that can affect drag of the bridle 800. In addition, the plurality of surface features 846 may include one or more of flutes, strakes, dimples, and tape with riblets. With this arrangement, the plurality of surface features 846 may comprise a combination of flutes, strakes, dimples and/or tape with riblets.

The plurality of drag-affecting surface features 846 may be arranged on the outer surface 844 of the jacket 840 in a variety of ways. For instance, in some embodiments, the plurality of drag-affecting surface features 846 may be disposed on the outer surface 844 along the long axis 802 of the bridle 800. Further, in some embodiments, the plurality of drag-affecting surface features 846 may be disposed on the outer surface 844 in a helical pattern. In some such embodiments, the helical pattern a be based on a fixed helical angle and/or a varying helical angle. Further still, in some embodiments, the plurality of drag-affecting surface features 846 may be disposed on the outer surface 844 in an oscillating path. Moreover, in some embodiments, at least a portion of the plurality of drag-affecting surface features 846 may be disposed on the outer surface 844 along the long axis 802 of the bridle 800, in a helical pattern with a fixed or varying helical angle, or in an oscillating path. With this arrangement, the plurality of drag-affecting surface features 846 may comprise surface features arranged on the outer surface 844 in a combination of being disposed along the long axis 802 of the tether 800, in a helical pattern with a fixed or varying helical angle, and/or in an oscillating path.

Although example bridles described above may be used in AWTs, in other examples, bridles described herein may be used for other applications, including overhead transmission, aerostats, subsea and marine applications, including offshore drilling and remotely operated underwater vehicles (ROVs), towing, mining, and/or bridges, among other possibilities.

### III. Conclusion

The particular arrangements shown in the Figures should not be viewed as limiting. It should be understood that other embodiments may include more or less of each element shown in a given Figure. Further, some of the illustrated elements may be combined or omitted. Yet further, an exemplary embodiment may include elements that are not illustrated in the Figures.

Additionally, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are contemplated herein.

What is claimed is:

1. An electro-mechanical bridle comprising:
a structural member comprising wrapped fiber filaments;
a tether thimble coupled to a first end of the structural member, configured to couple a tether to the bridle;
a wing thimble coupled to a second end of the structural member, wherein the wing thimble is configured to couple an aerial vehicle to the bridle; and
a plurality of electrical conductors coupled to the structural member and extending from the first end to the second end.

2. The electro-mechanical bridle of claim 1, wherein the tether thimble is coupled to the tether by a clevis and pin configuration.

3. The electro-mechanical bridle of claim 1, where the fiber filaments comprise carbon fiber filaments, aramid fiber filaments, poly(p-phenylene-2,6-benzobisoxazole) fibers, polyester fiber filaments, or ultra-high molecular weight polyethylene filaments.

4. The electro-mechanical bridle of claim 1, wherein the structural member comprises a bridle core.

5. The electro-mechanical bridle of claim 4, wherein the bridle core is approximately elliptical in shape and the plurality of electrical conductors extend from the first end to the second end along the leading edge of the bridle core.

6. The electro-mechanical bridle of claim 4, wherein the bridle core is approximately circular in shape and the plurality of electrical conductors extend from the first end to the second end along the bridle core.

7. The electro-mechanical bridle of claim 4, wherein the plurality of electrical conductors are helically coiled around the bridle core.

8. The electro-mechanical bridle of claim 4, wherein the bridle core contains one or more hollow tubes and wherein at least one of the plurality of electrical conductors is placed inside the one or more hollow tubes.

9. An electro-mechanical bridle system comprising:
a first bridle comprising:
a first structural member comprising a wrapped fiber;
a first tether thimble coupled to a first end of the first structural member;
a first wing thimble coupled to a second end of the first structural member, wherein the first wing thimble is configured to couple an aerial vehicle to the first bridle;
a second bridle comprising:
a second structural member comprising a wrapped fiber;
a second tether thimble coupled to a first end of the second structural member;
a second wing thimble coupled to a second end of the second structural member, wherein the second wing thimble is configured to couple an aerial vehicle to the second bridle;
wherein the first tether thimble and the second tether thimble are configured to couple the first bridle and the second bridle to a tether; and
a plurality of electrical conductors coupled to the first bridle and extending the length of the first structural member.

10. The electro-mechanical bridle system of claim 9, wherein the first bridle extends a first length, the second bridle extends a second length, and the first length is less than the second length.

11. The electro-mechanical bridle system of claim 9, wherein the first tether thimble and the second tether thimble are coupled to the tether via a two clevis and pin connector, a double clevis and pin connector, or a three pin connector.

12. The electro-mechanical bridle system of claim 9, further comprising:
a power transfer cable electrically coupled to the tether and the first bridle;
wherein the tether is an electrically conductive tether; and
wherein the power transfer cable is configured to transfer electrical power or signals between the electrically conductive tether and the electro-mechanical bridle system.

13. The electro-mechanical bridle system of claim 9, wherein at least one section of the first bridle or the second bridle are faired.

14. The electro-mechanical bridle system of claim 9, further comprising at least one sensor.

15. The electro-mechanical bridle system of claim 14, wherein the at least one sensor is a load sensor or a position sensor.

16. The electro-mechanical bridle system of claim 15, wherein the load sensor is a fiber bragg grating sensor, a load pin, or a direct strain gage.

17. An energy kite system comprising:
a ground station coupled to an electrically conductive tether;
a plurality of bridles, each bridle comprising:
a structural member comprising a wrapped fiber;
a tether thimble coupled to a first end of the structural member; and
a wing thimble coupled to a second end of the structural member;
wherein each tether thimble is coupled to an electrically conductive tether;
wherein each wing thimble is coupled to an aerial vehicle;
a plurality of electrical conductors extending the length of at least one of the plurality of bridles and electrically coupled to the aerial vehicle; and
a power transfer loop configured to transfer electrical power or signals between the electrically conductive tether and the electro-mechanical bridle system.

18. The energy kite system of claim 17, wherein at least one portion of at least one of the plurality of bridles is faired.

19. The energy kite system of claim 17, further comprising at least one sensor.

20. The energy kite system of claim 19, wherein the at least one sensor is a load sensor or a position sensor.
